(19) United States
(12) Patent Application Publication
(10) Pub. No.: US 2006/0189389 A1
(43) Pub. Date: Aug. 24, 2006

(54) System and method for allowing multiple participants to compete in an individual sport in real-time and non real-time

(76) Inventors: Dennis Hunter, Olney, MD (US); Michael Hieb, Superior, CO (US)

Correspondence Address: CAHN & SAMUELS LLP, 2000 P STREET NW, SUITE 200, WASHINGTON, DC, 20036, US

(21) Appl. No.: 11/062,965

(22) Filed: Feb. 23, 2005

(51) Int. Cl. G06F 17/00; G06F 19/00

(52) U.S. Cl. 463/42

(57) ABSTRACT

In at least one embodiment, the invention includes a method for allowing players to compete over a computer network in non-real time by using performances involving a individual sport, comprising: scheduling at least two performances involving the individual sport, collecting data from the at least two performances wherein the collected data represents results of real performances in the individual sport, and comparing the collected data in a reality-based competition between participants of the at least two performances to determine a winner, even though the actual performances of each competitor may have occurred independent of each other and separate from each other. In other embodiments, the invention also preferably provides one with a statistical report including ranking information which an individual sport participant may utilize to determine his performance strengths and weaknesses.

### I. FIELD OF THE INVENTION

The present invention relates generally to participatory sports, and more particularly, to a system and method of non-real time and real time competition between real people in participatory sports.

### II. BACKGROUND OF THE INVENTION

As used herein, the term “individual sport” refers to an organized physical activity defined by a set of rules where a participant's score is determined independently of the performance and/or score of its opponents, including, but not limited to, sports and activities such as golf, bowling, and darts. In such sports, it is normally desirable for multiple participants to compete to better enhance motivation to participate, for example. For instance, the individual sport of golf often involves multiple participants who compete with one another to determine who can obtain the best score. Although obtaining multiple participants in an individual sport is desired, a variety of problems often interfere or prevent such a situation from being realized.

Perhaps, one of the greatest problems in obtaining multiple participants in an individual sport is scheduling. For example, a group of friends may desire to participate in the individual sport of bowling. For convenience, participation in the individual sport is often prescheduled on the same day and the same time every week or month. As individual sports are often engaged in for relaxation or pleasure, convenient leisure time for each individual must be determined to allow him or her to participate. Due to jobs and managing a personal life, the individual's free leisure time may constantly conflict with the prescheduled time during which the individual is to participate in the individual sport. This often leads to difficulty or inability to consistently schedule participation in the individual sport. The scheduling problem is often exponentially increased, as the schedules of all individuals desiring to participate in the individual sport should be taken into consideration.

In situations where scheduling is actually accomplished without conflict, some participants may experience inconvenience. For example, a participant who does not prefer to rise during mornings may be forced to participate in an individual sport scheduled for a morning due to the difficulty in obtaining a schedule that is workable for all participants involved.

Another problem in obtaining multiple participation in an individual sport is availability. For example, participants, including friends, family members, relatives and personal acquaintances desiring to compete with one another are sometimes located in different geographical areas. Thus, due to both traveling time and traveling cost constraints, some participants may not be able to participate in a particular individual sport. For example, a Los Angeles resident may desire to compete against someone living in New York. Unless one of the two people is willing to bear the burden of expense in time and cost in traveling, the two people cannot compete against each other, as they simply are not in the same geographical location/place.

Yet another problem in obtaining multiple participants in an individual sport is that a participant may be unfamiliar with others with whom to participate. For instance, a first participant in a particular geographical area may not know of anyone who enjoys participating in a particular individual sport. As a result, the first participant may not be able to participate in the individual sport with another participant.

Similarly, a participant having a certain playing skill level may not be able to locate another individual having the same or a similar skill level in his or her geographical area. As a result, both participants may be denied the satisfaction that accompanies spirited, evenly matched competition. For example, if a first individual is a novice and a second individual is almost an expert player, competition between the two players would probably be too challenging for the novice player and not challenging enough for the player who is almost an expert. Thus, to find a compatible player, each of the participants may have to travel to other geographical areas, which may result in time and cost constraints as previously mentioned.

In light of the foregoing, what is needed is a system and method for allowing individuals to compete based on their real life performances in a particular individual sport in non real-time or real-time.

### III. SUMMARY OF THE INVENTION

The present invention collects scores and other statistics from at least two performances involving an individual sport. Scores and other statistics of a first of the at least two performances may be compared to the scores and other statistics of a second of the at least two performances, for example, thereby allowing participants to engage in a reality-based competition, in real-time or non real-time.

In at least one embodiment, a participant may register for a reality-based competition involving leagues. In addition to allowing the participant to engage in a reality-based competition, the present invention also allows a participant to assess his or her skill level and performance by providing him or her with information regarding the performances of other participants in a same individual sport.

In at least one embodiment, the invention includes a method for allowing players to compete by using their actual performances in an individual sport, comprising: scheduling at least two non real-time performances involving the individual sport, collecting data via a computer network or web presence from the performances, storing the data for comparison after both players have completed their individual performances/games and then comparing the collected data in a reality-based competition between participants in the performances to determine a winner.

In at least one embodiment, the invention also preferably provides one with a statistical report including ranking information which an individual sport participant may utilize to determine his performance strengths and weaknesses. Rankings may reflect a participant's/competitor's standing within a team, league, geographic region, national ranking and/or global ranking.

### DEFINITIONS

As used herein, the term “participant” and variations thereof such as participate and participation, are used interchangeably with the term “competitor” and variations thereof, as these terms are use to refer to activities and sports in which real people are competing in real, live, non-real time and/or real time competition. The present invention compares resulting scores/performances to determine individual, team and league winners in competition.

As used herein, the term “computer” or “workstation” is used to refer to any computer system with or without associated input and output devices. For example, a workstation or computer of the present invention may be a desktop computer, a laptop computer, palmtop computer, or personal digital assistant (PDA) or the like, with its associated input (for example, a keyboard) and output (for example, a computer display) devices.

As used herein, the term “computer program product” generally refers to media such as a computer program medium or a computer usable medium.

As used herein, the term “module,” “program module,” or “computer program module” is used to refer to a set of computer instructions for accomplishing a task. Thus, as used herein, a program module may or may not be embodied in the same electronic file or medium.

As used herein, the term “computer program language” includes a high-level programming language such as C, C++, Ada, LISP, Cobol, Fortran, and Beginners All-Purpose Symbolic Instruction Code (BASIC).

As used herein, the term “reality-based competition” refers to a non real-time or real-time sporting contest in which a number of competitors/players/participants, for example, two, use their actual live performances to compete against each other in accordance with a defined set of rules for the individual sport, for example, golf, bowling, darts, and other individual sports.

As used herein, the phrase “compete in non-real time,” or similar references refers to the ability of a number of players/competitors/participants to directly compete against each other although not actually present in the same place or playing at the same time. Competition in non-real time is achieved through data collection and storage of actual scores from real athletic/sporting performances of each player and then retrieving those scores of the players/competitors/participants involved and declaring a winner.

### IV. BRIEF DESCRIPTION OF THE DRAWINGS

Like reference numerals in the figures represent and refer to the same element or function throughout.

FIG. 1 illustrates an exemplary client-server computing environment in which the present invention may be employed including a server computing site and a plurality of client workstations according to at least one embodiment of the invention.

FIG. 2 is a flowchart illustrating the steps involved in an exemplary method for allowing individuals to engage in a reality-based competition over a computer network by utilizing results of performances involving an individual sport according to at least one embodiment of the invention.

FIG. 3 is a block diagram illustrating an exemplary reality-based sports league schema according to at least one embodiment of the invention.

### V. DETAILED DESCRIPTION OF THE DRAWINGS

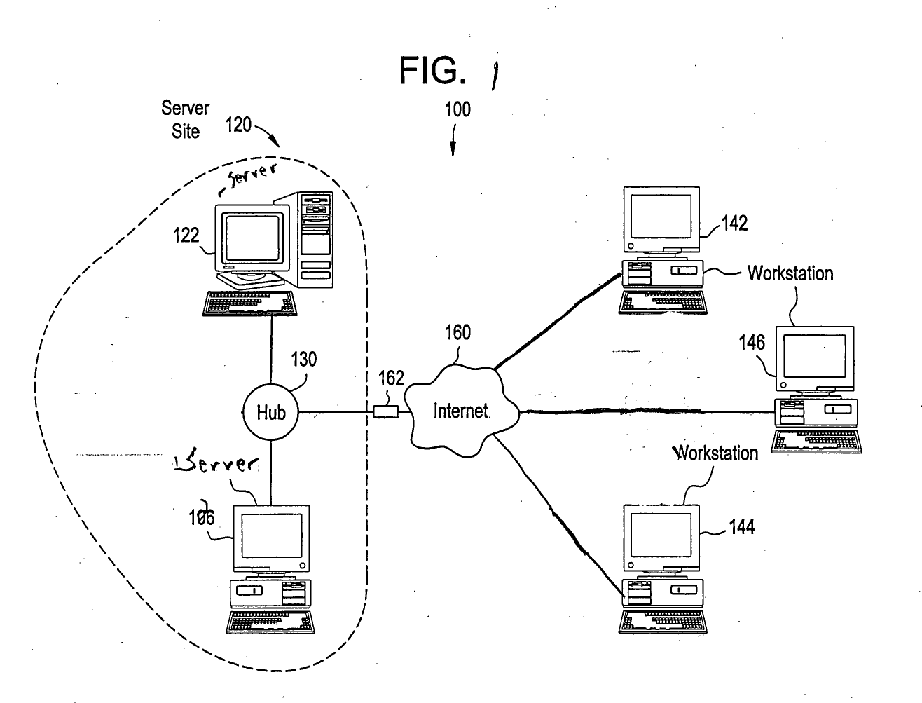

FIG. 1 illustrates an exemplary client-server computing environment 100 in which the present invention may be realized. Although FIG. 1 illustrates a client-server computing environment, it should be noted that the client-server computing environment is presented for purposes of illustration. After being presented with the disclosure herein, those skilled in the relevant art will realize that the invention may be realized in a variety of other environments. For example, the present invention may also be realized by a token ring computer network, as would be known to those of ordinary skill in the art after being presented with the disclosure herein.

The computing environment 100 preferably includes a server computing site 120 (for example, a server computing network or single server) and a plurality of client workstations 142, 144, and 146 coupled to the server computing site 120 via the Internet 160. For instance, several players may utilize the client workstations 142, 144, and 146 to communicate with the server computing site 120 to access the system of the present invention to compete. Each player may be located in a different geographical area. For example, a first player using client workstation 142 may be located in Kansas. A second player using client workstation 144 may be located in California. As the distance between the two players may serve as an impediment to competition between them, the players may wish to register with the system of the present invention to compete by utilizing results of their performances (e.g., scores) in a particular individual sport.

It should be noted that in at least one embodiment of the present invention, the server computing site 120 is preferably coupled to each of the plurality of client workstations 142, 144, and 146 directly via a main bridge (not shown). In such a configuration, the Internet 160 is replaced by the main bridge, and the system preferably operates on a private network (for example, an intranet), as opposed to the Internet 160. Regardless of the communication configuration, however, each client workstation 142, 144, and 146 preferably communicates with at least one of the computer servers (e.g., 122, 126) at the server computing site 120. The computer servers may include any type of data collection and/or polling device. The client workstations preferably include communications hardware and/or software to allow them to access at least one of the computer servers at the server computing site 120. For instance, in at least one embodiment of the present invention, web browser software such as Internet Explorer® or Netscape Navigator® is executed by the client workstations 142, 144 and 146. In particular, for example, in at least one embodiment, a client workstation is allowed to communicate with a computer server at the server computing site 120 to allow a player to register and engage in reality-based competition.

The computer servers 122 and 126 preferably communicate through the hub 130 according to a communications method well known to those of ordinary skill in the relevant art. For example, a system administrator using computer server 122 may email another system administrator using computer server 126. In at least one embodiment of the invention, however, the bridge or router 162 is not present. In such an embodiment, the hub 130 is preferably directly coupled to the Internet. In such a situation, the hub 130 is preferably replaced by a bridge or any other routing mechanism, as would be known to one skilled in the relevant art(s). It should be noted that the server computing site 120 might include a sole computer server in at least one embodiment of the present invention.

Each of the computer servers 122 and 126 (e.g., computer web server), for example, preferably includes a plurality of modules such as computer program modules for program execution. Execution of the computer program modules allows a user at a client workstation (e.g., 142, 144, and 146) to access the system of the present invention, as will be described in further detail herein below. In at least one embodiment, the computer program modules of the present invention include computer readable instructions. One skilled in the art will recognize that the computer readable instructions included in the computer program modules of the present invention can be in the form of any viable computer program language.

In addition to being implemented in software, the present invention may be implemented primarily in hardware using, for example, hardware components such as application specific integrated circuits (ASICs). Implementation of a hardware state machine so as to perform the functions described herein will be apparent to persons skilled in the art after being provided with the description herein.

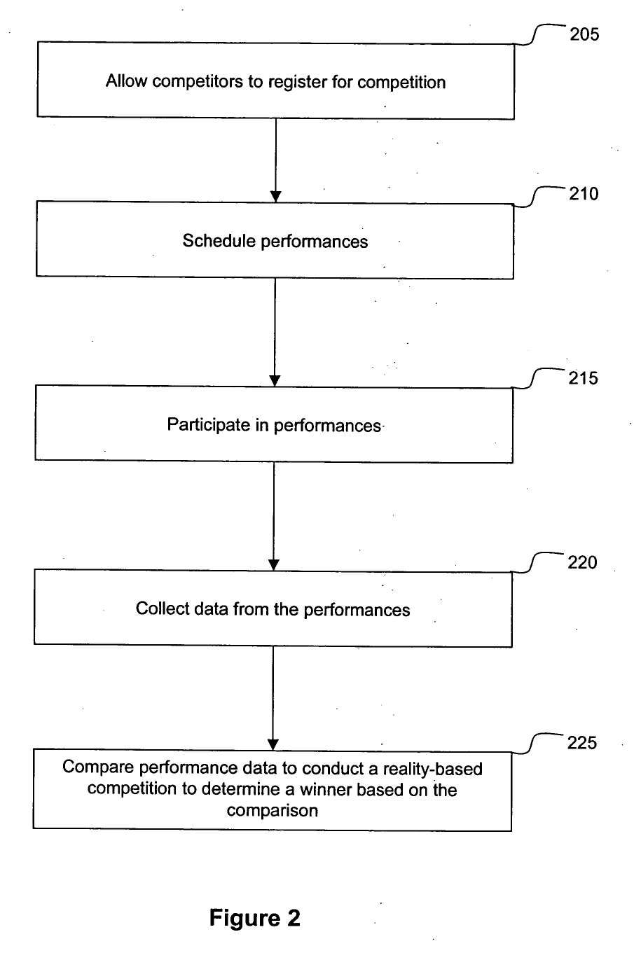

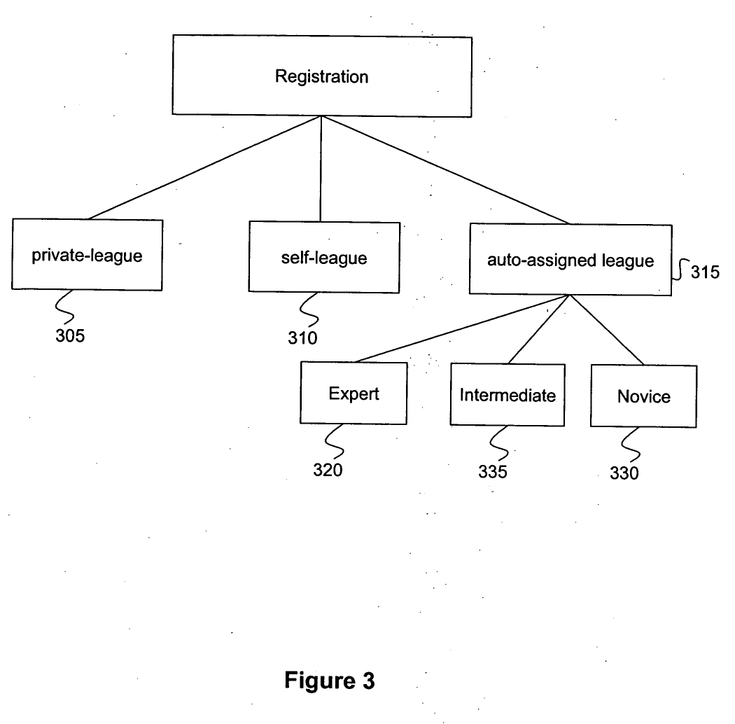

Now referring to FIG. 2, in step 205, individuals desiring to compete are preferably allowed to register for reality-based competition. In at least one embodiment, allowing an individual to register involves providing the individual with options in which he or she may register to be a part of a league such as a “private league” 305, a “self-league” 310, or an “auto-assigned league” 315, as illustrated in FIG. 3. Alternatively, individuals may register for specific games (i.e., performances) without joining a league.

Private league 305 is preferably a restricted league limited to members who know each other (e.g., a group of friends or co-workers). The self-league 310 is a league comprised of a sole participant to allow the participant to track progress of his performances involving a particular individual sport. The auto-assigned league 315 is a league including participants chosen by the system of the present invention in which the participants have like or similar skillsets.

In particular, a player utilizing client workstation 142, for example, may desire to register for the private league 305. In such an instance, the player accesses the website of the server computing site 120 (for example, competewewill.com). Upon accessing the website of the server computing site 120 from his or her client workstation, the player is preferably presented with a graphical user interface (GUI) which may be utilized to select one of the above-referenced options. Upon selecting either the private league 305, the self-league 310, or auto-assigned league 315, a respective module (e.g., computer program module) on one of the servers 122 or 126 at the server computing site 120 is executed. After being presented with the disclosure herein, those skilled in the relevant art will realize that a variety of other types of league schemes may be employed without departing from the spirit and scope of the present invention. For example, in at least one embodiment, individuals may register with a randomly assigned league wherein members are randomly assigned to a league as they register.

If the private league 305 is selected, the program module responsible for allowing the user to register with a private league is executed. A private league option preferably allows a user to create and/or register with one of a plurality of private leagues in at least one embodiment. After scores and statistics have been collected from performances, the scores and statistics of only members belonging to the particular private league will be compared to allow the league members to compete with one another. For example, if the first player in Kansas would like to create a tournament in which he, the second player in California, and a third player in Virginia compete, he or she preferably selects the private league registration option to create the league and specifies that the California player and the Virginia player will also be members of the league. In at least one embodiment of the invention, the creator of the league is provided with a registration key, e.g., a username and password, that allows future access to the league. The creator of the league preferably shares the league registration key with the other identified members to allow them to register with the league.

After the Kansas player creates the private league 305, the California player and the Virginia player may register with the particular private league. In at least one embodiment, this includes providing identifying information to the system such as the registration key initially offered to the creator of the league to verify league membership. In at least one embodiment, each player also receives an individual registration key during registration. It should be noted that a variety of type of demographic information might also be presented during registration.

Alternatively, if a player does not wish to be a part of a league in which he or she competes with other players, the player may elect to participate in a self-league 310. Each self-league 310 preferably allows a player to create and register with a league in which he or she is the sole player. The player who registers with a self-league is preferably allowed to track his or her individual sport performances in an attempt to discover what his strengths and weaknesses are. Such tracking can assist the player by allowing him to focus on areas of his performance needing improvement, thereby allowing him to improve the scores and statistics from his individual sport performances.

For example, a player who elects to register in a self-league is preferably allowed to obtain scores and statistics from all of his performances. The present invention preferably compares the player's scores and statistics from one performance to another performance and preferably provides the player with a statistical report including indications as to which performance was best (e.g., which of the player performance scores was best and/or which of the player performances included record setting game statistics, etc.). In at least one embodiment, the report includes a ranking of the player's performances based on how the player performed as indicated by particular statistics.

In keeping with the present invention, competitors may also register on-line with a league (auto-assigned league 315) in which the system of the present invention assigns players based on their reporting of their scores and/or other stats in past individual sport performances. Alternatively, the competitors may register on-site where the individual sport performances actually occur. To register on-line, a player at one of the client workstations 142, 144, or 146 preferably utilizes his browser software to access the website of the server computing site 120 and preferably selects an option for the auto-assigned league 315 in which individuals are assigned based on experience or skill level. Upon selection of the auto-assigned league 315, a module (e.g., a computer program module) on one of the computer servers 122 or 126 at the server computing site 120 is executed, thereby providing a player with a series of questions inquiring how well the player typically performs.

For example, in the individual sport of bowling, the computer program module provides a player with a series of questions including, “How long have you been bowling?”; “How often do you bowl?”; “How would you rate your skill level?”; “What is your average previous score?”; “How many strikes do you bowl on average in a game?”; and “How many spares do you bowl on average in a game?” After being presented with the disclosure herein, those skilled in the relevant art will realize that a variety of types of questions may be presented to the player in an attempt to accurately gauge his or her skill level to allow him or her to be automatically assigned to a particular auto-assign league based on his or her skill level.

For example, based on a series of questions such as the questions referenced above, it may be determined that the particular player should be assigned to the “expert” sports league 320. If a second player also elects to compete in the auto-assigned league 315 and it is determined that his or her responses to the series of questions are the same as or similar to those of the first player, he or she will also be assigned to the expert sports league 320 for competition based on scheduled games. Alternatively, if the second player elects to compete in the auto-assigned league 315 and it is determined that his or her responses to the series of questions are not like or similar to those of the first player, he or she will not be assigned to the expert sports league 320. Perhaps, instead of being assigned to the expert sports league 320, based on his or her responses to the questions, the second player may be automatically assigned to the novice sports league 330 or to the Intermediate sports league 335. In at least one embodiment, the system of the present invention reassigns league members based on their actual individual sport performances to obtain more accurate league assignments based on actual performances in the particular individual sport.

After being presented with the disclosure herein, those skilled in the relevant art will realize that a variety of specific league types may be utilized for each of the league types without departing from the scope and spirit of the present invention. For example, an individual may be randomly assigned to a league or assigned on the basis of geographical location. It should be noted that in at least one embodiment, an individual may register with more than one type of league (e.g., the auto-assigned league and the self-league).

Regardless of the league in which a player participates, before the reality-based competition between players may occur, individual sport performances (e.g., a bowling match) should be scheduled. In step 210, at least two performances involving an individual sport are preferably scheduled. For example, a first individual desiring to participate in a individual sport preferably uses client workstation 142 to access the server computing site 120 as described above. In at least one embodiment, the individual is preferably presented with a GUI into which he or she preferably enters a date and time at which he or she will participate in the individual sport. For example, players A, B, C, and D may all wish to compete with one another in the same league (for example, a private league). Player A may be located in Phoenix, Ariz. and may elect to participate in a particular individual sport on Jan. 5, 2005 at time 10:00 a.m. Player B may be located in Trenton, N.J. and may elect to participate in the individual sport at 11:00 a.m. on Jan. 6, 2005. Player C may be located in Albany, N.Y. and may elect to participate in the individual sport on Jan. 7, 2005 at 11:00 a.m. Finally, player D may be located in Washington, D.C. and may elect to participate in the individual sport at 10:00 a.m. on Jan. 5, 2005. In at least one embodiment, each individual preferably enters a location at which he or she will compete by playing an actual game in an individual sport. Scores are preferably transmitted via the Internet for data collection and storage for later retrieval and comparison between competitors after each of the competitors has played their actual game and reported their score(s).

It should be noted that the individuals desiring to participate in the individual sport need not contact each other to coordinate schedules, as the present invention allows the individuals to participate in the individual sport and eventually compete without requiring coordination of schedules and simultaneous availability. Entering the scheduling information preferably allows an individual desiring to participate to obtain information regarding when the other individuals in his or her league will participate in the individual sport. For example, player D may access the server computing site 120 to determine when player A is “signed up” to engage in bowling.

In step 215, participation in an individual sport actually occurs. For example, several bowling matches or games involving a different participant may be played in at least one embodiment of the invention. It should be noted that at any given time, multiple participation in a particular individual sport may be occurring. In other words, at any given time, multiple performances involving different participants may be occurring. For example, at 10:15 a.m. on Oct. 3, 2007, a first participant may be engaging in bowling in a first performance in Phoenix, a second participant may be engaging in bowling in a second performance in Chicago, a third participant may be engaging in bowling in a third performance in Okinawa, and a fourth participant may be engaging in bowling in a fourth performance in Rio De Janeiro.

In step 220, data representing results of the at least two performances is preferably collected from the performances. The collected data may be stored in a database. In at least one embodiment, the players themselves may record, input and upload their respective data (scores and statistics) to server computing site 120. Alternatively, server computing site 120 may directly interface with an individual sport scoring system and retrieve player scores directly from the scoring system without further player input.

In accordance with another embodiment, an appointed league representative is present at each game. At the end of each game, the respective league representative records the game data. The league representative then enters the game data into a regional computing site.

After all games have been completed, the server computing site 120 preferably polls each regional computing site to collect data from all games. Alternatively, a league representative may enter game data directly into the server-computing site 120 after each game or after all games. In at least one embodiment of the invention, statistical analysis is performed on the data, as would be known to one of ordinary skill in the relevant art after being provided with the disclosure herein.

In step 225, the data collected in step 215 from the at least two performances is preferably compared in a reality-based competition between the participants of the individual sport performances to determine a winner. As the competition is reality-based, a first player may compete against a second player regardless of time zones and geographical locations of each player in non real-time. For instance, referring again to FIG. 1, at 8:00 p.m. Pacific Time (PT), for example, Player A may access the server computing site 120 from the client workstation 144 and report his/her actual performance. As the scores from some or all league players' individual sport/athletic performances have already been transferred to the server computing site 120, Player A may play/compete/perform his/her game at any time he or she desires. Once scores for the competitors have been reported, players' performances can be compared.

Player B may reside in a state utilizing Eastern Standard Time (EST) and may believe that 11:00 p.m., EST (that is, 8:00 p.m. PST) is too late to engage in playing or competing. Because the actual playing of the sport by each competitor occurs in non-real time competition independently of each other, players A and B may choose to play the individual sport at any time, preferably at a time that is convenient to each player, for example. Scores for each player are transmitted, e.g., after each performance, for data storage and later comparison to determine the winner of the game.

Instead of allowing a player to select a competitor (for example, Player A decides to engage in competition with Player B), in at least one embodiment, the present invention randomly develops which players will compete with each other in a particular league competition. For example, in a first league competition, the system of the invention may determine that Player A will compete against Player D. A winner from that particular competition is then determined based on data from each of their individual sport performances. In at least one embodiment, another individual sport performance will be scheduled between Players A and D, and the data from the performances will be reported to the server computing site 120 (that is, data from each performance will be collected). A competition is then determined based on data from each of those performances. After Players A and D engage in a specified number of individual sport performances and a winner is determined from a competition based on data from the performances, the player having won the most reality-based competitions based on the individual sport performances preferably advances in the league (e.g., advancement to the next reality-based competition).

For instance, if it is determined that Player A has won three out of five competitions, then Player A advances in the league (for example, Player A continues to engage in competition with other players). Player D is then preferably eliminated from league play. The present invention then determines (e.g., randomly) which player in the league will compete against Player A. Similarly, after a specified number of competitions between Player A and his or her next opponent, a winner is determined. The process preferably continues until a league champion has been determined.

It should be understood that the above-referenced description of league competition is offered as an example. Those skilled in the relevant art will realize that a variety of competition schemes may be utilized without departing from the scope and spirit of the present invention. It should also be noted that competition in the present invention may also occur in real-time. In such a situation, for example, scores from each individual sport performance may be reported to a server computer as they occur (or shortly after they occur) to allow participants to compete in real-time. For example, while Player A (located in New York) and B (located in California) are participating in a particular individual sport (that is, while Player A is engaging in a first performance and player B is engaging in a second performance), their scores are simultaneously reported to a server computer which actually compares the scores as they are received, thereby allowing Players A and B to engage in reality-based competition in real-time. After being presented with the disclosure herein, those skilled in the relevant art will realize that real-time competition may be conducted with the present invention in a variety of ways.

In addition to electing to compete in a league, a player may elect to obtain a statistical report in which he or she is ranked with other players in his or her league, city, region, geographical area, nation, etc. (or his or her games are ranked based on game performance in a self-competitive league, as described above), for example, based on his or her game data (e.g., statistics), as would be known to those of ordinary skill in the relevant art after being presented with the disclosure herein. In instances of competition, players may be ranked to indicate their strength of play for evaluating their performances within a given league, geographically, nationally, and globally.

Those skilled in the art will also appreciate that various adaptations and modifications of the above-described embodiments can be configured without departing from the scope and spirit of the present invention. Therefore, it is to be understood that, within the scope of the appended claims, the invention may be practiced and constructed other than as specifically described herein.

We claim:

1. A method for allowing individuals to compete in an individual sport over a computer network by using real scores or performances occurring in non-real time or real time, comprising:
scheduling at least two performances involving the individual sport;
collecting data from said at least two performances, said collected data representing results of said at least two performances;
comparing said collected data in a reality-based competition between participants of said at least two performances to determine a winner.

2. The method of claim 1, further comprising, before said scheduling step, registering individuals who will participate in said reality-based competition.

3. The method of claim 2, wherein said registering occurs on-line.

4. The method of claim 2, wherein said registering occurs at an on-site location where said performances occur.

5. The method of claim 2, further comprising, after said registering step, assigning individuals to a reality-based competitive sports league.

6. The method of claim 5, wherein said assigning includes assigning individuals to a reality-based private competitive sports league.

7. The method of claim 5, wherein said assigning includes assigning individuals to a reality-based competitive sports league based on at least one of geographical location of said individuals, relationship preferences of said individuals, and random assignments.

8. The method of claim 5, wherein said assigning includes assigning individuals to a reality-based competitive sports league based on determination of skill levels of said individuals.

9. The method of claim 5, wherein said assigning includes assigning individuals to a reality-based self-competitive sports league.

10. The method of claim 1, further comprising providing a statistical report including rankings based on said collected data.

11. The method of claim 10, further comprising, before said providing step, performing statistical analysis on said collected data.

12. A system for allowing individuals to compete over a computer network by using results of real performances involving a same individual sport, comprising:
a first module for scheduling at least two performances involving the individual sport;
a second module for collecting data from said at least two performances, said collected data representing results of said at least two performances;
a third module for comparing said collected data in a reality-based competition between individuals of said at least two performances to determine a winner; and
at least one server computer accessible via the computer network by at least one client computer, said at least one server computer for executing said first, second, and third modules to allow a user of said client computer to interact with the system.

13. The system of claim 12, further comprising, a fourth module for conducting on-line registration before said scheduling.

14. The system of claim 12, further comprising, a fourth module for assigning individuals to a reality-based competitive sports league.

15. The system of claim 12, further comprising, a fourth module for assigning individuals to a reality-based private competitive sports league.

16. The system of claim 12, further comprising a fourth module for assigning an individual to a reality-based competitive sports league based on geographical location of said individual.

17. The system of claim 12, further comprising a fourth module for assigning individuals to a reality-based competitive sports league based on determinations of skill levels of said individuals.

18. The system of claim 12, further comprising a fourth module for assigning individuals to a reality-based self-competitive sports league.

19. The system of claim 12, further comprising a fourth module for assigning individuals to a randomly assigned league.

20. The system of claim 12, further comprising a fourth module for assigning individuals to a reality-based league based on groupings of competitors into teams such that aggregate scores of competitors of a first team can be compared to aggregate scores of competitors of a second team to determine a winner.
